(19) United States
(12) Patent Application Publication
(10) Pub. No.: US 2026/0158525 A1
(43) Pub. Date: Jun. 11, 2026

(54) Self-Cleaning Transfer Hose

(71) Applicant: Ronny Wood, Lehigh Acres, FL (US)

(72) Inventor: Ronny Wood, Lehigh Acres, FL (US)

(21) Appl. No.: 19/410,076

(22) Filed: Dec. 5, 2025

Related U.S. Application Data
(60) Provisional application No. 63/728,720, filed on Dec. 6, 2024.

(51) Int. Cl. B08B 9/032; B05B 1/20; F16L 11/12

(52) U.S. Cl. CPC B08B 9/0321; B05B 1/20; F16L 11/12

(57) ABSTRACT

A self-cleaning transfer hose having a first end with a self-cleaning base including a detergent pod housing, a water hose connector, and a one-way valve. A second end includes an outlet and a double walled hose with spiraled channel formed by the walls connecting the first end to the second end. The double walled hose is perforated on the interior and configured to spray water on an opposing interior surface of the hose.

### FIELD OF THE INVENTION

The present invention relates generally to the field of transfer hoses. More particularly, the present invention relates generally to the cleaning of transfer hoses.

### BACKGROUND

Transfer hoses are used in a variety of industries from sewage management, e.g., RV wastewater drain hoses to construction, e.g., cement transfer hoses.

RV wastewater transfer hoses, also known as sewer hoses, are critical components for transferring sewage and gray water (wastewater from sinks, showers, and washing machines) from a recreational vehicle (RV) to an external waste disposal system, like a dump station. These hoses are designed to handle the transfer of waste materials in a safe, efficient, and hygienic manner.

RV wastewater transfer hoses are a vital piece of equipment for any RV owner. They help safely and hygienically transfer sewage and gray water from the RV's holding tanks to waste disposal systems at campgrounds or RV parks. With durable materials, secure fittings, and convenient features like flexibility and compact storage, these hoses are designed to provide a reliable solution for managing wastewater while traveling. Proper maintenance and care will ensure that the hoses function effectively and continue to support the convenience and comfort of RV life.

RV wastewater transfer hoses are typically used in situations where an RV is parked at a campsite, RV park, or any other location with a waste disposal facility. Since RVs have holding tanks that collect wastewater, these hoses are essential for emptying those tanks into the facility's sewage system.

Proper wastewater management is crucial to maintaining hygiene and preventing contamination when RVing. Without an effective and durable transfer hose, managing sewage can become difficult and unpleasant. These hoses are designed to withstand exposure to waste, as well as weather and environmental factors.

There are a variety of wastewater management transfer hoses. Standard sewer hoses are typically 10 to 20 feet long and are made from durable materials like PVC or rubber. They are designed to connect the RV's waste outlet to a campground or dump station's sewage inlet. Some standard hoses come in collapsible or coiled designs for easier storage.

The materials used for RV wastewater transfer hoses are selected for their durability, flexibility, and resistance to chemicals and environmental factors. Most RV sewer hoses are designed to be long enough to reach dump stations, which are often located some distance from the RV. Flexible hoses allow for easy coiling, storage, and adjusting to different site layouts. Many hoses range from 10 to 20 feet long, with some expandable versions extending even further.

To use an RV waste water transfer hose you attach one end of the hose to the RV's waste outlet. Most RVs have a designated black water (sewage) and gray water (sink and shower waste) outlet. Then the other end of the hose is attached to the waste disposal system at the dump station. Many dump stations feature a standard sewage connection, with either a bayonet fitting or a screw-on connection. Finally, the RV's waste valve is opened to allow the wastewater to flow into the dump station. Many RVs feature separate valves for black water and gray water, and it's advisable to empty the black water tank first, followed by the gray water tank to help flush out any remaining waste.

After emptying the tanks, the final step is to rinse and sanitize the hose to prevent odors and contamination. Some RV parks offer hose rinse stations specifically for this purpose. However, despite best efforts, it can be difficult to completely clean the interior of the wastewater transfer hose. Such can result in unpleasant odors upon storage of the hose and generally unsanitary conditions.

Accordingly, there remains a need for a solution to at least one of the aforementioned problems. For instance, there is an established need for a means to effectively clean the interior of a transfer hose such as an RV wastewater hose or a concrete transfer hose.

### SUMMARY OF THE INVENTION

There is provided a self-cleaning transfer hose. The self-cleaning transfer hose has a hollow tubular spiral spring along an interior of the hose. The hollow tubular spiral spring has a plurality of perforations there along. The self-cleaning transfer hose also contains a hose connection end which can be connected to a source of water and/or cleaning solution. There is also provided a method of cleaning a transfer hose which comprises connecting the hose connection end to a source of water and/or cleaning solution and passing the water and/or cleaning solution throughout the length of the hollow tubular spiral spring such that water and/or cleaning solution sprays throughout the interior passageway of the transfer hose through the plurality of perforations along the interior of the transfer hose to clean the transfer hose.

It has been surprisingly found that by employing the self-cleaning transfer hose, the transfer hose can be completely cleaned along its interior with minimal effort. In a first implementation of the invention there can be provided a self-cleaning transfer hose including a length of transfer hose having a proximal end and a distal end and a hollow tubular spiral spring extending along an interior surface of the transfer hose from the proximal end to the distal end, the hollow tubular spiral spring containing a channel therethrough along an axis of the hollow tubular spiral spring, and containing a plurality of perforations which pass from an interior of the channel to an exterior of the hollow tubular spiral spring along the length of the hollow tubular spiral spring, and wherein the perforations face an interior passageway of the transfer hose; and, a hose connection end located at the proximal end of the transfer hose, which hose connection end is connected to a proximal end of the hollow tubular spiral spring.

In one aspect of the invention, the self-cleaning transfer hose can be a recreational vehicle waste transfer hose, a motor home waste transfer hose, a travel trailer waste transfer hose, a camper waste transfer hose, an airplane waste transfer hose, a boat waste transfer hose and a concrete transfer hose.

The transfer hose can comprise a cover, made of cloth, or a polymer material, which overlays the hollow tubular spiral spring. In another embodiment the cover can be adhered to the hollow tubular spiral spring to form the transfer hose using any conventional adhesive.

In another aspect of the invention, the length of transfer hose can be from about 10 feet up to about 30 feet, preferably from about 10 feet up to about 20 feet.

In yet another aspect of the invention, the hollow tubular spiral spring can have a diameter of from about 0.5 mm up to about 2 mm, preferably about 1 mm. In yet even another aspect of the invention, wherein the plurality of perforations can comprise from about 4 to about 8 perforations per square inch length of the hollow tubular spiral spring. In yet one other aspect of the invention, wherein the plurality of perforations can be evenly spaced along the length of the hollow tubular spiral spring. In yet even one other aspect of the invention, wherein the perforations can have a size and configuration that allows fluid to flow through the perforations when the transfer hose is in use, thereby assisting in the cleaning of the interior passageway of the transfer hose. In another aspect of the invention wherein the perforations can be circular. In another aspect of the invention the plurality of perforations are angled to point to different points along an interior of the passageway of the transfer hose. In yet still one other aspect of the invention, the hollow tubular spiral spring can be constructed from a material that is resistant to corrosion and wear, such as steel, stainless steel, aluminum and the like. In yet still even another aspect of the invention, wherein the hollow tubular spiral spring can be helically wound along the length of the transfer hose. In another aspect of the invention, the hollow tubular spiral spring can be affixed to a cover of the transfer hose by thermal bonding thereto. In yet another aspect of the invention, wherein the hollow tubular spiral spring can have a cross section which is circular, oval or elliptical. In another aspect of the invention, the channel in the hollow tubular spiral spring can have a circular or trapezoidal cross section. In yet another aspect of the invention, the hollow tubular spiral spring can further comprise an indentation along a longitudinal length of the hollow tubular spiral spring, and wherein a cover of the transfer hose can contain corded piping along the exterior surface of the transfer hose which corded piping is embedded in the indentation to provide for affixation of the cover to the hollow tubular spiral spring. The indentation can be in the cross-section shape of an upside down omega, i.e., having a broader bottom and a narrower top to provide for secure connection of the piping in the indentation. In one aspect of the invention, wherein the hose connection end can further comprise a quick-connect fitting. In another aspect of the invention, wherein the hose connection end can have an adapter to adapt the connection of the proximal end of the hollow tubular spiral spring to a garden hose connection.

In a second implementation of the invention there can be provided herein a method of cleaning a transfer with a self-cleaning transfer hose having a length of transfer hose having a proximal end and a distal end and a hollow tubular spiral spring extending along an interior surface of the transfer hose from the proximal end to the distal end, the hollow tubular spiral spring containing a channel therethrough along an axis of the hollow tubular spiral spring, and containing a plurality of perforations which pass from an interior of the channel to an exterior of the hollow tubular spiral spring along the length of the hollow tubular spiral spring, and wherein the perforations face an interior passageway of the transfer hose; and a hose connection end located at the proximal end of the transfer hose, which hose connection end is connected to a proximal end of the hollow tubular spiral spring, connecting the hose connection end to a source of water and/or cleaning solution; and, passing the water and/or cleaning solution from the source of water and/or cleaning solution through the hose connection end and throughout the hollow tubular spiral spring. In some aspects of the invention, the source water may be provided by a garden hose.

In another aspect of the invention, there may be a method of cleaning an RV waste water transfer hose consisting of providing a self-cleaning RV waste water transfer hose including: a length of RV waste water transfer hose having a proximal end and a distal end and a hollow tubular spiral spring extending along an interior surface of the RV waste water transfer hose from the proximal end to the distal end, the hollow tubular spiral spring containing a channel therethrough along an axis of the hollow tubular spiral spring, and containing a plurality of perforations which pass from an interior of the channel to an exterior of the hollow tubular spiral spring along the length of the hollow tubular spiral spring, and wherein the perforations face an interior passageway of the RV waste water transfer hose; and a hose connection end located at the proximal end of the RV waste water transfer hose, which hose connection end is connected to a proximal end of the hollow tubular spiral spring, connecting the hose connection end to a source of water and/or cleaning solution; and passing the water and/or cleaning solution from the source of water and/or cleaning solution through the hose connection end and throughout the hollow tubular spiral spring.

In another embodiment, a first end of the transfer hose may include a self-cleaning base with a detergent pod housing, a water hose connector, a spiral tube first end, and a one-way valve. A second end may include an outlet and spiral tube second end. Connecting the first end to the second end may be the transfer hose itself. In this embodiment, the spiral tube is perforated on the interior of the hose and structured to spray water on an opposing interior surface of the hose.

Another embodiment of the invention may include the self-cleaning transfer hose having a first end with a self-cleaning base, a detergent pod housing, a water hose connector, and a one-way valve. It may likewise have a second end with an outlet. However, in this embodiment, instead of a spiraled tube, the transfer hose may be a double walled hose with spiraled channel formed by the hose walls connecting the first end to the second end. Therefore, the transfer hose may be a double walled hose that is perforated on the interior and structured to spray water on an opposing interior surface of the double walled hose.

### BRIEF DESCRIPTION OF THE DRAWINGS

FIG. 1 illustrates a perspective view of a length of transfer hose.

FIG. 2 illustrates an end view of an interior of the length of transfer hose.

FIG. 3 illustrates a cut away view of the length of transfer hose along lines 3-3 of FIG. showing the hollow tubular spiral spring extending along an interior surface of the transfer hose and showing the hose connection end connected to a source of water.

FIG. 4 illustrates an end view of the transfer hose of FIG. 3 illustrating water passing through the hollow tubular spiral spring and emanating through the plurality of perforations along the length of the transfer hose interior.

FIG. 5 illustrate a close-up view of a manner of attaching a cover of the transfer hose to the hollow tubular spiral spring of the transfer hose.

FIG. 6 illustrates a section of the transfer hose showing the manner of attachment of the cover to the hollow tubular spiral spring of the transfer hose.

FIG. 7 illustrates the transfer hose of the present invention attached to a water source which is connected to the hose connection end of the transfer hose while emptying the contents of an RV waste water tank.

FIG. 8 Illustrates another embodiment of the invention with additional features included on the self-cleaning transfer hose.

FIG. 9 illustrates a component of the of the self-cleaning transfer hose according to the embodiment illustrated in FIG. 8.

FIG. 10 illustrates a component of the of the self-cleaning transfer hose according to the embodiment illustrated in FIG. 8.

FIG. 11 illustrates a component of the of the self-cleaning transfer hose according to the embodiment illustrated in FIG. 8.

FIG. 12 illustrates is a segmented view of the embodiment of the invention illustrated in FIG. 8 with additional features included on the self-cleaning transfer hose.

FIG. 13 illustrates is a segmented view of another embodiment of the invention with additional features included on the self-cleaning transfer hose.

### DETAILED DESCRIPTION OF THE INVENTION

The present invention will now be described in detail with reference to the accompanying drawings. The embodiment descriptions are illustrative and not intended to be limiting in any way. Other embodiments of the invention will readily suggest themselves to persons with ordinary skill in the art after having the benefit of this disclosure. Accordingly, the following embodiments are set forth without any loss of generality and without imposing limitation upon the claimed invention.

Directional terms such as “above” “below” “upper” “lower” and other like terms are used for the convenience of the reader in reference to the drawings. Additionally, the description may contain terminology to convey position, orientation, and direction without departing from the principles of the present invention. Such positional language should be taken in context of the represented drawings.

Quantitative terms such as “generally” “substantially” “mostly” and other like terms are used to mean that the referred object, characteristic, or quality constitutes a majority of the referenced subject. Likewise, use of the terms such as first and second do not necessarily designate a limitation of quantity. Such terms may be used as a method of describing the presence of at least one of the referenced elements or may provide a means of differentiating orientation. The meaning of any term within this description is dependent upon the context within which it is used, and the meaning may be expressly modified.

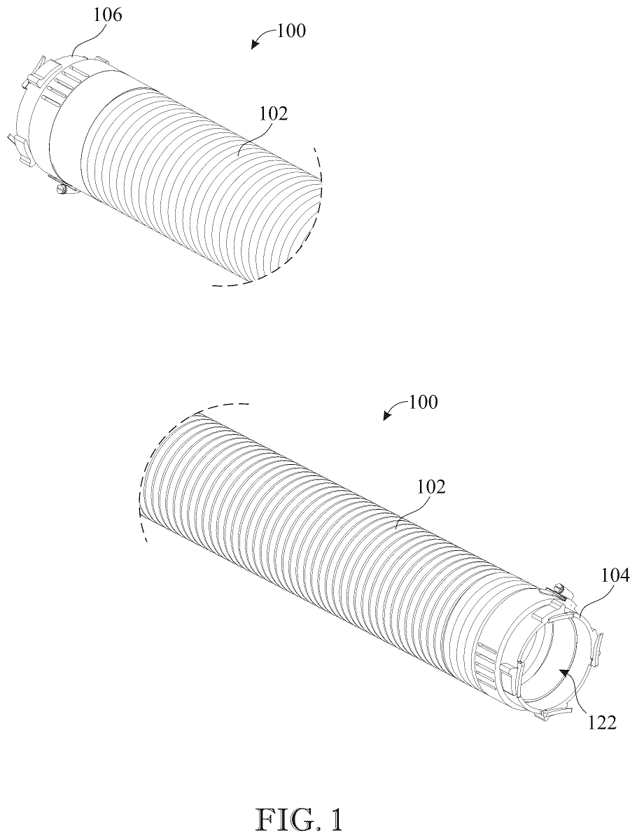

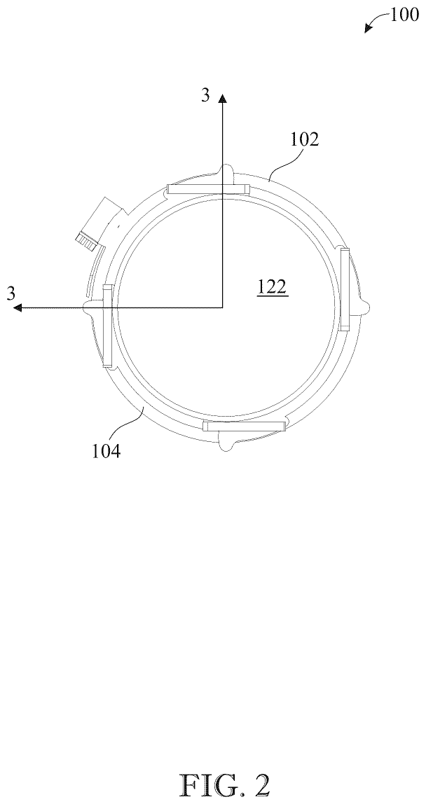

Referring now to FIGS. 1, 2, 3, 4 and 7 there is provided a self-cleaning transfer hose 100 (hereinafter transfer hose 100). The transfer hose 100 comprises a length of transfer hose 102 having a first end 104 and a second end 106 and a hollow tubular spiral spring 108 extending along an interior surface 110 of the transfer hose 100 from the first end 104 to the second end 106. The hollow tubular spiral spring 108 contains a channel 112 therethrough along an axis 114 of the hollow tubular spiral spring 108, and containing a plurality of perforations 116 which pass from an interior 118 of the channel 112 to an exterior 120 of the hollow tubular spiral spring 108 along the length of the hollow tubular spiral spring 108, and wherein the perforations 116 face an interior passageway 122 of the transfer hose 100. The transfer hose 100 also contains a hose connection end 124 located at the first end 104 of the transfer hose 100, which hose connection end 124 is connected to a proximal end 130 of the hollow tubular spiral spring 108.

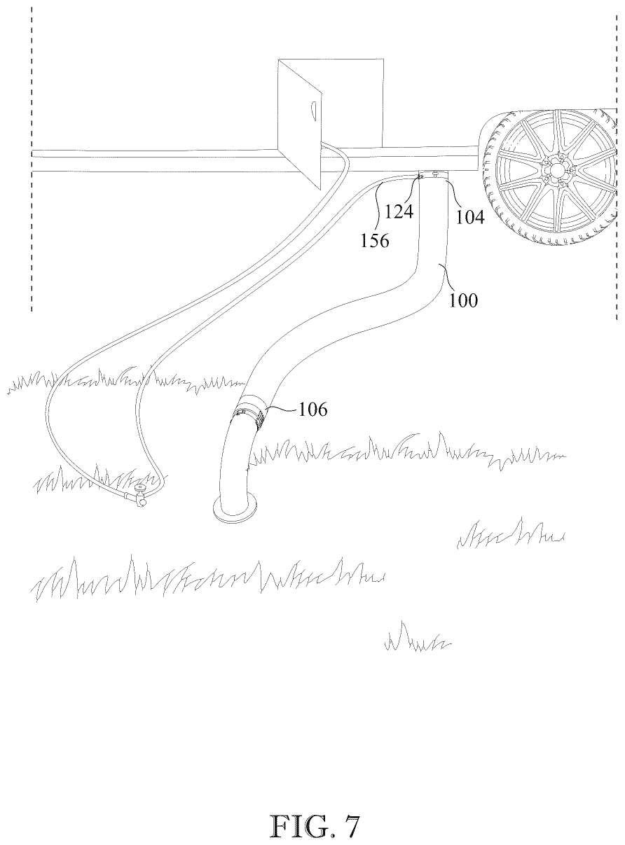

In one aspect of the invention, the self-cleaning transfer hose can be a recreational vehicle waste transfer hose as is shown in FIG. 7.

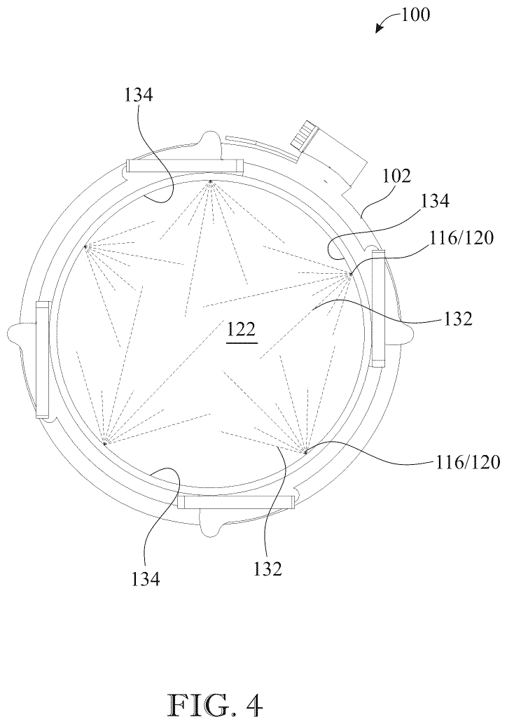

Referring now to FIG. 4 the perforations 116 can have a size and configuration that allows fluid 132 to flow through the perforations 116 when the transfer hose 100 is in use, thereby assisting in the cleaning of the interior passageway 122 of the transfer hose 100. As shown in FIG. 4, the plurality of perforations 116 can be angled to point to different points along an interior 134 of the passageway 122 of the transfer hose 100.

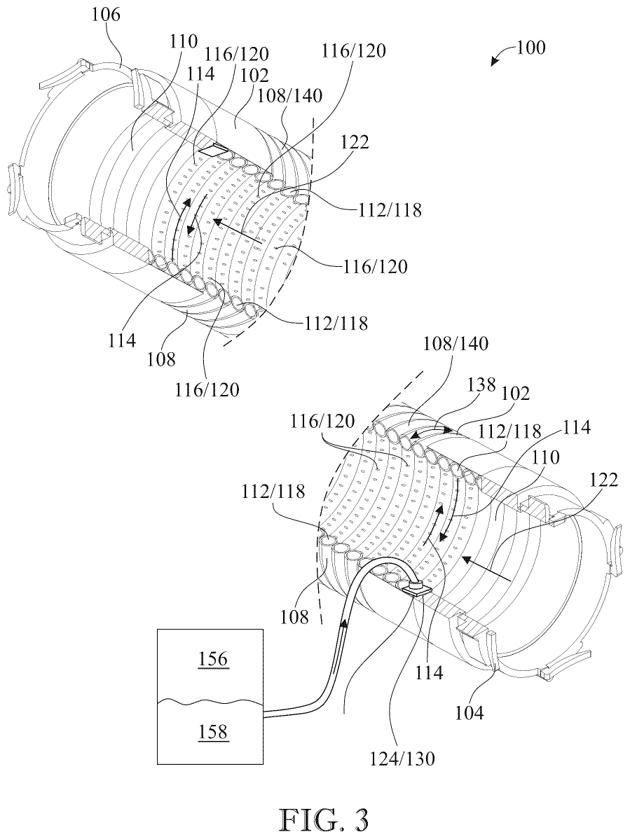

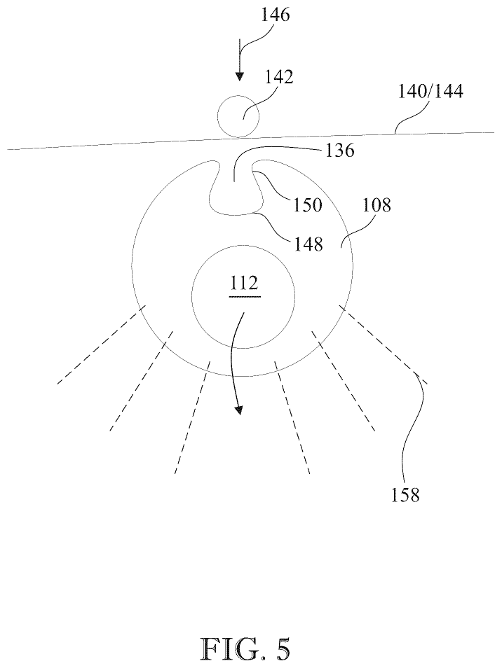

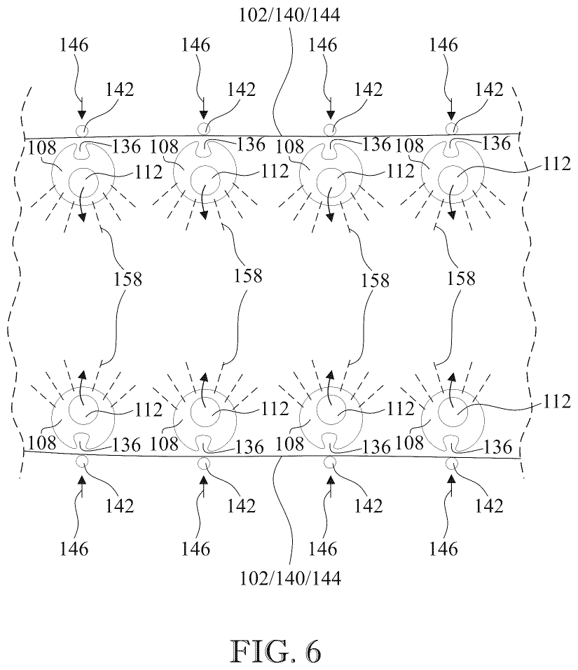

Referring now to FIGS. 5 and 6, the hollow tubular spiral spring 108 can further comprise an indentation 136 along a longitudinal length 138 (see FIG. 3) of the hollow tubular spiral spring 108, and wherein a cover 140 of the transfer hose 100 can contain corded piping 142 along the exterior surface 144 of the transfer hose 100 which corded piping 142 is embedded in the indentation 136 by pressing the corded piping 142 in the direction of the arrow 146 to provide for affixation of the cover 140 to the hollow tubular spiral spring 108. The indentation 136 can be in the cross-section shape of an upside-down omega, i.e., having a broader bottom 148 and a narrower top 150 to provide for secure connection of the piping 142 in the indentation 136.

In another embodiment the cover 140 can be adhered to the hollow tubular spiral spring 108 to form the transfer hose 100 using any conventional adhesive (not shown). As shown in FIG. 3, the transfer hose 100 and length of transfer hose 102 can comprise the cover 140 over the hollow tubular spiral spring 108, and this is shown in another view in FIG. 6. In a further embodiment, the hollow tubular spring 108 can have the corded piping 142 inserted into the indentation 136 with adhesive (not shown) being placed in the indentation 136.

In one aspect of the invention, wherein the hose connection end 124 can further comprise a quick-connect fitting 152.

In another aspect of the invention, the hose connection end 124 may have an adapter 154 to adapt the connection of the proximal end 130 of the hollow tubular spiral spring 108 to a garden hose connection 156 or other source of water or cleaning fluid 156.

In another embodiment of the invention may be a method of cleaning a transfer hose 100 including providing a self-cleaning transfer hose 100 as described herein, connecting the hose connection end 124 to a source of water and/or cleaning solution 156, and passing the water and/or cleaning solution 158 from the source of water and/or cleaning solution 156 through the hose connection end 124 and throughout the hollow tubular spiral spring 108.

In another aspect of the invention, the source of water may be provided by a garden hose.

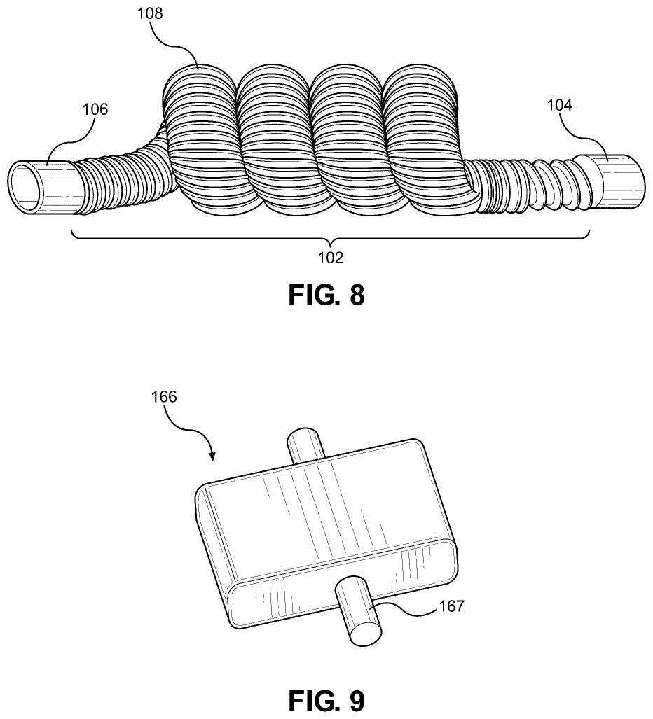

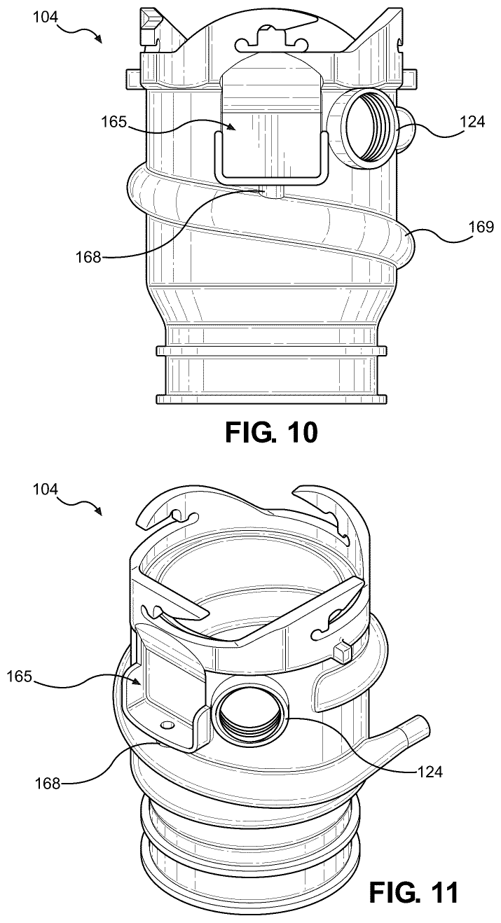

FIGS. 8, 9, 10, and 11, illustrate another embodiment of the invention with additional features included on the self-cleaning transfer hose 100. A first end 104 of the transfer hose 100 may include a self-cleaning base 107 with a detergent pod housing 165, a water hose connector 124, a spiral tube first end 175, and a one-way valve 168. A second end 106 may include an outlet and spiral tube second end 177. Connecting the second end 106 to the first end 104 may be the transfer hose 100 itself. In this embodiment, the spiral tube 178 is perforated on the interior of the hose 100 and structured to spray water on an opposing interior surface of the hose 100.

In this embodiment, the spiral tube 178 may be integrally formed into folds of the hose 100 and the detergent pod housing 165 may include a connector 179 permeating into the spiral tube 178. The connector 179 may include a one-way valve 168 structured to receive a detergent pod protrusion 166 and may be operable to emit detergent into the hose 100 when streaming fluid. The detergent from the detergent pod housing 165 may be drawn through the connector 179, via a Bernoulli's principled low-pressure system. Additionally, the spiral tube 178 may include a standard water hose opening connector and a standard sized threaded end connector. The detergent pod housing 165 may be structured to receive a removably connected detergent pod 166 utilizing a friction fit connector 179. Furthermore, the spiral tube 178 itself may include a cleaning valve 180 within its body and the spiral tube 178 itself may be closed at its second end 177.

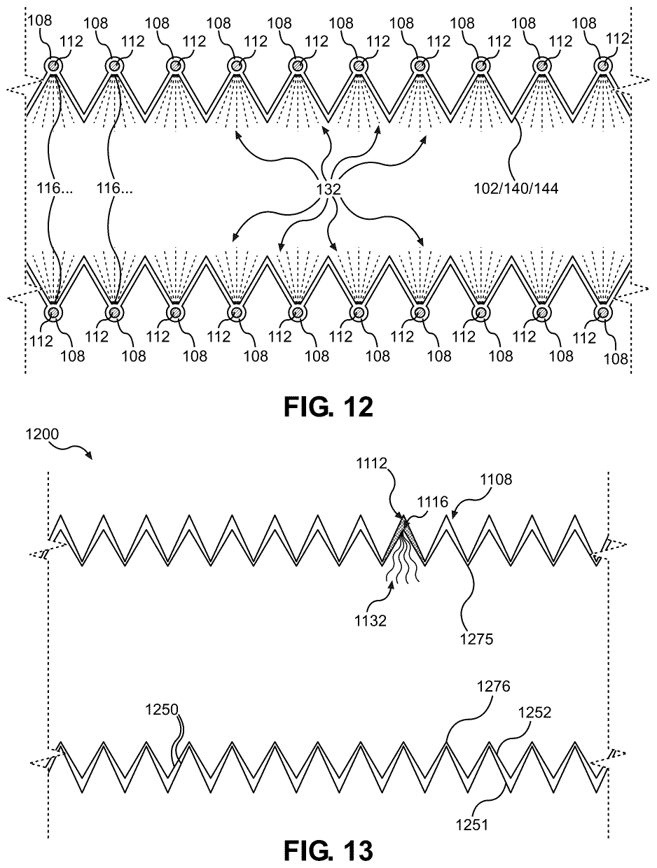

Referring additionally to FIG. 12, the perforations 116 can have a size and configuration that allows fluid 132 to flow through the perforations 116 and reach the opposing surface of the interior of the transfer hose 100 when the transfer hose 100 is in use. The perforations 116 may face an interior passageway 112 of the transfer hose 100. The water supply spiral channel 108 may run on the exterior of the transfer hose and seamlessly adhered to it.

Referring now to FIG. 13, another embodiment of the invention may include the self-cleaning transfer hose 1200 having a first end 104 with a self-cleaning base 107, a detergent pod housing 165, a water hose connector 124, and a one-way valve 168. It may likewise have a second end 106 with an outlet 176. However, in this embodiment, instead of a spiraled tube 178, the transfer hose 1200 may be a double walled hose 1200 with spiraled channel 1112 formed by the hose walls 1108 connecting the first end 104 to the second end 106. Therefore, the transfer hose 1200 may be a double walled hose 1200 that is perforated on the interior and structured to spray water 1132 on an opposing interior surface of the double walled hose 1200.

In this embodiment, the double wall 1250 may be made of a first interior accordion 1251 and a second exterior accordion 1252 integrally connected at the most interior points of both accordions 1275, 1276. As such, the first interior accordion 1251 and the second exterior accordion 1252 may form the self-cleaning transfer hose 1200. Like the previous embodiment, there may be a one-way cleaning valve 168 proximate the hose second end 106.

The first interior accordion 1251 may include vertices 1116 extending outward from its central longitudinal axis that include perforations for water 1132 to spray into the hose interior. Similar to the previous embodiment, the first end 104 may include a water hose connector 124 integrally formed with the double walled spiraled channel 1112 operable to allow fluid to enter the spiraled channel 1112. In some embodiments, the inside wall may include a plurality of angled holes, or perforations, spiraling around the hose circumference from the first end 104 to the second end 106. In some embodiments, the second exterior accordion 1252 may include a smooth exterior surface and the first interior accordion 1251 may include a surface with angled holes extending outward from the interior of the hose 1200.

It should be noted that in both the spiraled tube and spiraled channel embodiments, the spiraled channels are structured to spray clean water into the transfer hose 100, 1200 interior simultaneous with wastewater drainage traveling within that hose interior. The sprayed water is structured to wash the entire interior surface of the self-cleaning hose 100, 1200. Likewise, the detergent pod housing 165 may include a connector 179 permeating into the spiraled channel 178 structured to deliver detergent infused clean water into the hose interior to clean the hose 100, 1200.

That which is claimed is:

1. A self-cleaning transfer hose comprising
a first end with a self-cleaning base comprising
a detergent pod housing
a water hose connector
a spiral tube first end, and
a one-way valve;
a second end comprising an outlet and spiral tube second end;
a hose with spiral tube connecting the first end and second end;
wherein the spiral tube is perforated on the interior of the hose configured to spray water on an opposing interior surface of the hose.

2. The self-cleaning transfer hose of claim 1 wherein the spiral tube is integrally formed into folds of the hose.

3. The self-cleaning transfer hose of claim 1 wherein the detergent pod housing includes a connector permeating into the spiral tube.

4. The self-cleaning transfer hose of claim 3 wherein the connector includes a one-way valve configured to receive a detergent pod protrusion operable to emit detergent into the hose when streaming fluid.

5. The self-cleaning transfer hose of claim 4 wherein detergent from the detergent pod housing is drawn through the connector via a Bernoulli's principled low-pressure system.

6. The self-cleaning transfer hose of claim 1 wherein the spiral tube includes a standard water hose opening connector and a standard sized threaded end connector.

7. The self-cleaning transfer hose of claim 1 wherein the detergent pod housing is configured to receive a removably connected detergent pod comprising a friction fit connector.

8. The self-cleaning transfer hose of claim 1 wherein the spiral tube comprises a cleaning valve within its body and is closed at the second end.

9. A self-cleaning transfer hose comprising
a first end with a self-cleaning base comprising
a detergent pod housing
a water hose connector
a one-way valve;
a second end comprising an outlet;
a double walled hose with spiraled channel formed by the walls connecting the first end to the second end,
wherein the double walled hose is perforated on the interior and configured to spray water on an opposing interior surface of the hose.

10. The self-cleaning transfer hose of claim 9 wherein the double wall is comprised of a first interior accordion and a second exterior accordion integrally connected at the most interior points of both accordions.

11. The self-cleaning transfer hose of claim 10 wherein the first interior accordion and the second exterior according form the self-cleaning transfer hose.

12. The self-cleaning transfer hose of claim 9 further comprising a one-way cleaning valve proximate the hose second end.

13. The self-cleaning transfer hose of claim 9 wherein the first interior accordion comprises vertices extending outward from its central longitudinal axis that include perforations for water to spray into the hose interior.

14. The self-cleaning transfer hose of claim 9 wherein the first end comprises a water hose connector integrally formed with the double walled spiraled channel operable to allow fluid to enter the spiraled channel.

15. The self-cleaning transfer hose of claim 9 wherein the hose includes an inside wall comprised of a plurality of angled holes spiraling around the hose circumference from the first end to the second end.

16. The self-cleaning transfer hose of claim 15 wherein the second exterior accordion comprises a smooth exterior surface and the first interior accordion comprises a surface with angled holes extending outward from the interior of the hose.

17. A self-cleaning transfer hose comprising
a first end with a self-cleaning base comprising
a detergent pod housing
a water hose connector
a one-way valve;
a second end comprising an outlet;
a double walled hose with spiraled channel formed by the walls connecting the first end to the second end,
wherein the double walled hose is perforated with angled holes spiraling around the hose circumference on the interior and configured to spray water on an opposing interior surface of the hose.

18. The self-cleaning transfer hose of claim 18 wherein the spiraled channel is configured to spray clean water into the transfer hose interior simultaneous with wastewater drainage traveling within that hose interior.

19. The self-cleaning transfer hose of claim 18 wherein the sprayed water is configured to wash the entire interior surface of the self-cleaning hose.

20. The self-cleaning transfer hose of claim 18 wherein the detergent pod housing includes a connector permeating into the spiraled channel configured to deliver detergent infused clean water into the hose interior to clean the hose.
